(19) United States
(12) Patent Application Publication
(10) Pub. No.: US 2024/0309253 A1
(43) Pub. Date: Sep. 19, 2024

(54) BIOBASED ADHESIVE COMPOSITIONS AND METHODS OF MAKING THE SAME

(71) Applicant: H.B. Fuller Company, St. Paul, MN (US)

(72) Inventors: Thomas F. Kauffman, Easton, PA (US); Kevin P. Davis, Woodbury, MN (US); Justin Bates, Clarklake, MN (US)

(21) Appl. No.: 18/573,010

(22) PCT Filed: Jun. 23, 2022
(86) PCT No.: PCT/US2022/073102

§ 371 Date: Dec. 21, 2023

Related U.S. Application Data
(60) Provisional application No. 63/202,789, filed on Jun. 24, 2021.

(51) Int. Cl. C09J 197/00; C09J 5/06; C09J 123/08

(52) U.S. Cl. CPC C09J 197/005; C09J 5/06; C09J 123/0853

(57) ABSTRACT

An adhesive composition comprising a lignin-based tackifying agent exhibiting a glass transition temperature no greater than 120° C. and a thermoplastic polymer.

### FIELD

The present disclosure relates to adhesive compositions. More particularly, the present disclosure relates to adhesive compositions that include bio-based materials.

### BACKGROUND

Adhesive compositions are used in a variety of applications that require bonding two substrates together One kind of adhesive composition is a hot melt adhesive composition.

A hot melt adhesive composition is generally applied in a liquid or molten state and forms a bond as it cools and solidifies. Hot melt adhesive compositions can be applied by extruding the adhesive composition at elevated temperatures directly onto a substrate to form a structural bond with another substrate as the temperature of the adhesive composition cools.

Hot melt adhesive compositions may be used in packaging applications (e.g., for bonding cardboard and corrugated boards), for nonwoven applications (e.g., disposable articles such as diapers), bookbinding, and footwear manufacturing, among other applications.

Hot melt adhesive compositions often include components such as polymers, tackifying agents, plasticizers, and waxes. Such components are commonly derived from petroleum-based feedstocks. It is desired that hot melt adhesive compositions be formed of components derived from renewable resources.

### SUMMARY

Disclosed herein is an adhesive composition comprising a lignin-based tackifying agent exhibiting a glass transition temperature from 30° C. to 120° C. and a thermoplastic polymer. The adhesive composition exhibits a softening point at a temperature below 160° C. In some aspects, the lignin-based tackifying agent has a weight average molecular weight of no greater than 6000. In some aspects, the lignin-based tackifying agent has a weight average molecular weight of no greater than 4000. In some aspects, the lignin-based tackifying agent has a weight average molecular weight of no greater than 3100. In some aspects, the lignin-based tackifying agent has a weight average molecular weight of no greater than 3000. In some aspects, the lignin-based tackifying agent exhibits a glass transition temperature from 40° C. to 120° C. In some aspects, the lignin-based tackifying agent exhibits a glass transition temperature from 50° C. to 120° C. In some aspects, the adhesive composition exhibits a softening point at a temperature below 120° C. In some aspects, the adhesive composition exhibits a softening point at a temperature below 100° C. In some aspects, the lignin-based tackifying agent is derived from depolymerized lignin. In some aspects, the adhesive composition does not include a tackifying agent other than the lignin-based tackifying agent. In some aspects, the adhesive composition includes a tackifying agent consisting essentially of depolymerized lignin. In some aspects, the adhesive composition further comprises a second tackifying agent. In some aspects, the adhesive composition further comprises a non-lignin based tackifying agent. In some aspects, the adhesive composition further comprises a non-lignin based tackifying agent that is bio-based. In some aspects, the thermoplastic polymer is a petroleum-based polymer. In some aspects, the thermoplastic polymer is an ethylene-vinyl acetate polymer. In some aspects, the thermoplastic polymer is an ethylene-vinyl acetate polymer having a vinyl acetate content of at least 28% by weight, based on the total weight of the thermoplastic polymer. In some aspects, the adhesive composition further comprises a wax. In some aspects, the adhesive composition further comprises an antioxidant

In some aspects, the adhesive composition includes from 20% to 70% by weight a lignin-based tackifying agent, and from 30% to 80% by weight a thermoplastic polymer, all based on the total weight of the adhesive composition. In some aspects, the adhesive composition includes from 30% to 50% by weight a lignin-based tackifying agent, from 30% to 50% by weight a thermoplastic polymer, and from 15% to 30% by weight a wax, all based on the total weight of the adhesive composition. In some aspects, the adhesive composition exhibits a greater than 90% fiber tearing bond at −18° C. when tested according to the Fiber Tear Test. In some aspects, the adhesive composition exhibits a greater than 80% fiber tearing bond at 4° C. when tested according to the Fiber Tear Test. In some aspects, the adhesive composition exhibits a greater than 50% fiber tearing bond at 23° C. when tested according to the Fiber Tear Test. In some aspects, the adhesive composition exhibits a greater than 80% fiber tearing bond at 54° C. when tested according to the Fiber Tear Test. In some aspects, the adhesive composition is at least one selected from the group of hot melt adhesive and asphaltic adhesive. In some aspects, the adhesive composition exhibits a viscosity of no greater than 100,000 cP at a temperature from 177° C. to 178° C. In some aspects, the lignin-based tackifying agent is a hydrogenated lignin-based tackifying agent.

Disclosed herein is an adhesive composition comprising a lignin-based tackifying agent having a weight average molecular weight of no greater than 6000, and a thermoplastic polymer. In some aspects, the lignin-based tackifying agent bas a weight average molecular weight of no greater than 5000, no greater than 4000, no greater than 3500, no greater than 3100, or even no greater than 3000. The adhesive composition exhibits a softening point at a temperature below 160° C. In some aspects, the adhesive composition exhibits a softening point at a temperature below 150° C. In some aspects, the lignin-based tackifying agent exhibits a glass transition temperature from 30° C. to 120° C. In some aspects, the lignin-based tackifying agent exhibits a glass transition temperature from 40° C. to 120° C. In some aspects, the lignin-based tackifying agent exhibits a glass transition temperature from 50° C. to 120° C. In some aspects, the adhesive composition exhibits a softening point at a temperature below 120° C. In some aspects, the adhesive composition exhibits a softening point at a temperature below 100° C. In some aspects, the lignin-based tackifying agent is derived from depolymerized lignin. In some aspects, the adhesive composition does not include a tackifying agent other than the lignin-based tackifying agent. In some aspects, the adhesive composition includes a tackifying agent consisting essentially of depolymerized lignin. In some aspects, the adhesive composition further comprises a second tackifying agent. In some aspects, the adhesive composition further comprises a non-lignin based tackifying agent. In some aspects, the adhesive composition further comprises a non-lignin based tackifying agent that is bio-based In some aspects, the thermoplastic polymer is a petroleum-based polymer. In some aspects, the thermoplastic polymer is an ethylene-vinyl acetate polymer. In some aspects, the thermoplastic polymer is an ethylene-vinyl acetate polymer having a vinyl acetate content of at least 28% by weight, based on the total weight of the thermoplastic polymer. In some aspects, the adhesive composition further comprises a wax. In some aspects, the adhesive composition further comprises an antioxidant.

In some aspects, the adhesive composition includes from 20% to 70% by weight the lignin-based tackifying agent, and from 30% to 80% by weight the polymer, all based on the total weight of the adhesive composition. In some aspects, the adhesive composition includes from 30% to 50% by weight the lignin-based tackifying agent, from 30% to 50% by weight the thermoplastic polymer, and from 15% to 30% by weight a wax, all based on the total weight of the adhesive composition. In some aspects, the adhesive composition exhibits a greater than 90% fiber tearing bond at −18° C. when tested according to the Fiber Tear Test. In some aspects, the adhesive composition exhibits a greater than 80% fiber tearing bond at 4° C. when tested according to the Fiber Tear Test. In some aspects, the adhesive composition exhibits a greater than 50% fiber tearing bond at 22° C. when tested according to the Fiber Tear Test. In some aspects, the adhesive composition exhibits a greater than 80% fiber tearing bond at 54° C. when tested according to the Fiber Tear Test In some aspects, the adhesive composition is at least one selected from the group of hot melt adhesive and asphaltic adhesive. In some aspects, the adhesive composition exhibits a viscosity of no greater than 100,000 cP at a temperature from 177° C. to 178° C. In some aspects, the lignin-based tackifying agent is a hydrogenated lignin-based tackifying agent.

Disclosed herein is an adhesive composition comprising a lignin-based tackifying agent exhibiting a glass transition temperature from 30° C. to 120° C. and having a weight average molecular weight of no greater than 6000, and a thermoplastic polymer; and the adhesive composition exhibits a softening point at a temperature below 160° C. In some aspects, the lignin-based tackifying agent has a weight average molecular weight of no greater than 5500, no greater than 5000, no greater than 4500, no greater than 4000, no greater than 3500, no greater than 3100, or even no greater than 3000. In some aspects, the adhesive composition exhibits a softening point at a temperature below 150° C. In some aspects, the lignin-based tackifying agent exhibits a glass transition temperature from 40° C. to 120° C. In some aspects, the lignin-based tackifying agent exhibits a glass transition temperature from 50° C. to 120° C. In some aspects, the adhesive composition exhibits a softening point at a temperature below 120° C. In some aspects, the adhesive composition exhibits a softening point at a temperature below 100° C. In some aspects, the lignin-based tackifying agent is derived from depolymerized lignin. In some aspects, the adhesive composition does not include a tackifying agent other than the lignin-based tackifying agent. In some aspects, the adhesive composition includes a tackifying agent consisting essentially of depolymerized lignin. In some aspects, the adhesive composition further comprises a second tackifying agent. In some aspects, the adhesive composition further comprises a non-lignin based tackifying agent. In some aspects, the adhesive composition further comprises a non-lignin based tackifying agent that is bio-based. In some aspects, the thermoplastic polymer is a petroleum-based polymer. In some aspects, the thermoplastic polymer is an ethylene-vinyl acetate polymer. In some aspects, the thermoplastic polymer is an ethylene-vinyl acetate polymer having a vinyl acetate content of at least 28% by weight, based on the total weight of the thermoplastic polymer. In some aspects, the adhesive composition further comprises a wax. In some aspects, the adhesive composition further comprises an antioxidant.

In some aspects, the adhesive composition includes from 20% to 70% by weight the lignin-based tackifying agent, and from 30% to 80% by weight the polymer, all based on the total weight of the adhesive composition. In some aspects, the adhesive composition includes from 30% to 50% by weight the lignin-based tackifying agent, and from 30% to 50% by weight the thermoplastic polymer, from 15% to 30% by weight a wax, all based on the total weight of the adhesive composition. In some aspects, the adhesive composition exhibits a greater than 90% fiber tearing bond at −18° C. when tested according to the Fiber Tear Test. In some aspects, the adhesive composition exhibits a greater than 80% fiber tearing bond at 4° C. when tested according to the Fiber Tear Test. In some aspects, the adhesive composition exhibits a greater than 50% fiber tearing bond at 23° C. when tested according to the Fiber Tear Test. In some aspects, the adhesive composition exhibits a greater than 80% fiber tearing bond at 54° C. when tested according to the Fiber Tear Test. In some aspects, the adhesive composition is at least one selected from the group of hot melt adhesive and asphaltic adhesive. In some aspects, the adhesive composition exhibits a viscosity of no greater than 100,000 cP at a temperature from 177° C. to 178° C. In some aspects, the lignin-based tackifying agent is a hydrogenated lignin-based tackifying agent.

Disclosed herein is an adhesive composition comprising a lignin-based tackifying agent exhibiting a glass transition temperature from 30° C. to 120° C. and having a weight average molecular weight of no greater than 6000, and a thermoplastic polymer; and the adhesive composition exhibits a viscosity of no greater than 100,000 cP at a temperature from 177° C. to 178° C. In some aspects, the lignin-based tackifying agent has a weight average molecular weight of no greater than 5500, no greater than 5000, no greater than 4500, no greater than 4000, no greater than 3500, no greater than 3100, or even no greater than 3000. In some aspects, the adhesive composition exhibits a viscosity of no greater than 80,000 cP at a temperature from 177° C. to 178° C. In some aspects, the adhesive composition exhibits a viscosity of no greater than 10,000 cP at a temperature from 177° C. to 178° C. In some aspects, the adhesive composition exhibits a viscosity of no greater than 5,000 cP at a temperature from 177° C. to 178° C. In some aspects, the lignin-based tackifying agent exhibits a glass transition temperature from 40° C. to 120° C. In some aspects, the lignin-based tackifying agent exhibits a glass transition temperature from 50° C. to 120° C. In some aspects, the adhesive composition exhibits a softening point at a temperature below 120° C. In some aspects, the adhesive composition exhibits a softening point at a temperature below 100° C. In some aspects, the lignin-based tackifying agent is derived from depolymerized lignin. In some aspects, the adhesive composition does not include a tackifying agent other than the lignin-based tackifying agent. In some aspects, the adhesive composition includes a tackifying agent consisting essentially of depolymerized lignin. In some aspects, the adhesive composition further comprises a second tackifying agent. In some aspects, the adhesive composition further comprises a non-lignin based tackifying agent. In some aspects, the adhesive composition further comprises a non-lignin based tackifying agent that is bio-based. In some aspects, the thermoplastic polymer is a petroleum-based polymer. In some aspects, the thermoplastic polymer is an ethylene-vinyl acetate polymer.

In some aspects, the thermoplastic polymer is an ethylene-vinyl acetate polymer having a vinyl acetate content of at least 28% by weight, based on the total weight of the thermoplastic polymer. In some aspects, the adhesive composition further comprises a wax. In some aspects, the adhesive composition further comprises an antioxidant. In some aspects, the adhesive composition includes from 20% to 70% by weight the lignin-based tackifying agent, and from 30% to 80% by weight the thermoplastic polymer, all based on the total weight of the adhesive composition. In some aspects, the adhesive composition includes from 30% to 50% by weight the lignin-based tackifying agent, from 30% to 50% by weight the thermoplastic polymer, and from 15% to 30% by weight a wax, all based on the total weight of the adhesive composition. In some aspects, the adhesive composition exhibits a greater than 90% fiber tearing bond at −18° C. when tested according to the Fiber Tear Test. In some aspects, the adhesive composition exhibits a greater than 80% fiber tearing bond at 4° C. when tested according to the Fiber Tear Test. In some aspects, the adhesive composition exhibits a greater than 50% fiber tearing bond at 23° C. when tested according to the Fiber Tear Test. In some aspects, the adhesive composition exhibits a greater than 80% fiber tearing bond at 54° C. when tested according to the Fiber Tear Test. In some aspects, the adhesive composition is at least one selected from the group of hot melt adhesive and asphaltic adhesive. In some aspects, the adhesive composition exhibits a viscosity of no greater than 100,000 cP at a temperature from 177° C. to 178° C. In some aspects, the lignin-based tackifying agent is a hydrogenated lignin-based tackifying agent.

These embodiments are intended to be within the scope of the invention disclosed herein. These and other embodiments of the present invention will become readily apparent to those skilled in the art from the following detailed description of the various embodiments, the invention not being limited to any particularly preferred embodiment(s) disclosed.

### GLOSSARY

As used herein, the term “renewable resource” refers to a resource that is produced by a process at a rate comparable to its rate of consumption.

As used herein, a “bio-based material” is defined as a material made from substances derived from living (or once-living) organisms that have been alive within the previous 100 years.

As used herein, “lignin-based” is defined as including at least 90% by weight a material that has lignin as a starting component.

As used herein, “depolymerized lignin” is defined as a material taken from lignin that has undergone a process whereby the molecular weight of the material is lower than the molecular weight of the lignin before it has undergone the process.

As used herein, a tackifying agent or tackifier is a chemical compound included in a composition to increase the surface tack of the composition.

### DETAILED DESCRIPTION

Disclosed herein is an adhesive composition that includes bio-based materials. The adhesive composition is suitable as a hot melt adhesive. The adhesive composition includes a tackifying agent of depolymerized lignin.

Disclosed herein is an adhesive composition that includes a lignin-based tackifying agent exhibiting a glass transition temperature no greater than 120° C. Disclosed herein is an adhesive composition that includes a lignin-based tackifying agent having a weight average molecular weight no greater than 6000. In some embodiments, the adhesive composition includes a lignin-based tackifying agent having a weight average molecular weight no greater than 3100.

Adhesive compositions include various components. A hot melt adhesive can include a thermoplastic polymer and a tackifying agent. In some embodiments, a hot melt adhesive can include components such as a wax, a plasticizer, and an antioxidant.

The adhesive composition can include from 20% by weight to 95% by weight, from 30% by weight to 95% by weight, from 40% by weight to 95% by weight, from 50% by weight to 95% by weight, from 60% by weight to 95% by weight, from 70% by weight to 95% by weight, or even from 75% by weight to 95% by weight, bio-based materials The bio-based materials can be selected from lignin-based tackifying agent, non-lignin-based tackifying agent, polymer, wax and plasticizer.

### Tackifying Agent

The adhesive composition includes one or more tackifying agents. The adhesive composition includes at least one lignin-based tackifying agent (e.g., at least 90% of the mass of the tackifying agent may be made up of components sourced from lignin). In some embodiments, the adhesive composition may further include one or more non-lignin-based tackifying agents.

In a preferred embodiment, when the adhesive composition includes one or more non-lignin-based tackifying agents, they are bio-based tackifying agents (e.g., rosin based tackifying agents and terpene based tackifying agents).

Suitable tackifying agents that may be included in the adhesive composition include those exhibiting a glass transition temperature (Tg) from 30° C., 40° C., 50° C., 60° C., or 70° C., to 80° C., 90° C., 100° C., 110° C., or 120° C., or a glass transition temperature between any pair of the foregoing values. For example, suitable tackifying agents may include those exhibiting a glass transition temperature from 30° C. to 40° C., from 30° C. to 50° C., from 30° C. to 60° C., from 30° C. to 70° C., from 30° C. to 80° C., from 30° C. to 90° C., from 30° C. to 100° C., from 30° C. to 110° C., or even from 30° C. to 120° C. Suitable tackifying agents may include those exhibiting a glass transition temperature from 40° C. to 50° C., from 40° C. to 60° C., from 40° C. to 70° C., from 40° C. to 80° C., from 40° C. to 90° C., from 40° C. to 100° C., from 40° C. to 110° C., or from 40° C. to 120° C. Suitable tackifying agents may include those exhibiting a glass transition temperature from 50° C. to 60° C., from 50° C. to 70° C., from 50° C. to 80° C., from 50° C. to 90° C., from 50° C. to 100° C., from 50° C. to 110° C., or even from 50° C. to 120° C. In a preferred embodiment, the tackifying agent exhibits a glass transition temperature from 30° C. to 70° C., from 40° C. to 70° C., or from 40° C. to 60° C.

Suitable tackifying agents that may be included in the adhesive composition include those having a weight average molecular weight (Mw) from about 100, about 200, about 300, about 400, about 500, about 900, about 1000, or about 1500, to about 2000, about 2500, about 3000, about 3100, about 3500, 4000, 4500, 5000, 5500, or about 6000, or a molecular weight between any pair of the foregoing values For example, suitable tackifying agents may include those having a weight average molecular weight from 100 to 6000, from 100 to 5000, from 100 to 4000, from 100 to 3100, from 100 to 3000, from 100 to 2500, from 100 to 2000, from 100 to 1500. Suitable tackifying agents may include those having a weight average molecular weight from 500 to 6000, from 500 to 5000, from 500 to 4000, from 500 to 3100, from 500 to 3000, from 500 to 2500, from 500 to 2000, or from 500 to 1500. Suitable tackifying agents may include those having a weight average molecular weight from 1000 to 6000, from 1000 to 5000, from 1000 to 4000, from 1000 to 3100, from 1000 to 2500, from 1000 to 2000, or from 1000 to 1500. In a preferred embodiment, the tackifying agent is a lignin-based tackifying agent having a molecular weight no greater than 3500, no greater than 3100, or even no greater than 3000 For example, the tackifying agent may be a lignin-based tackifying agent having a molecular weight no greater than 2900, no greater than 2500, no greater than 2000, or even no greater than 1500.

Suitable tackifying agents that may be included in the adhesive composition include those exhibiting a suitable glass transition temperature (Tg) and a suitable molecular weight. For example, suitable tackifying agents may include those exhibiting a glass transition temperature from 30° C. to 40° C., from 30° C. to 50° C., from 30° C. to 60° C., from 30° C. to 70° C., from 30° C. to 80° C., from 30° C. to 90° C., from 30° C. to 100° C., from 30° C. to 110° C., or even from 30° C. to 120° C.; or a glass transition temperature from 40° C. to 50° C., from 40° C. to 60° C., from 40° C. to 70° C., from 40° C. to 80° C., from 40° C. to 90° C., from 40° C. to 100° C., from 40° C. to 110° C., or from 40° C. to 120° C.; or a glass transition temperature from 50° C. to 60° C., from 50° C. to 70° C., from 50° C. to 80° C., from 50° C. to 90° C., from 50° C. to 100° C., from 50° C. to 110° C., or even from 50° C. to 120° C.; or a glass transition temperature from 60° C. to 70° C., from 60° C. to 80° C., from 60° C. to 90° C., from 60° C. to 100° C., from 60° C. to 110° C., or even from 60° C. to 120° C.; and having a weight average molecular weight (Mw) from about 100, about 200, about 300, about 400, about 500, about 900, or about 1000, to about 1500, about 2000, about 2500, about 3000, about 3100, about 3500, about 4000, about 4500, about 5000, about 5500, or about 6000, or a molecular weight between any pair of the foregoing values, for example from 100 to 6000, from 100 to 5500, from 100 to 5000, from 100 to 4500, from 100 to 4000, from 100 to 3500, from 100 to 3100, from 100 to 2500, from 100 to 2000, from 100 to 1500; or a weight average molecular weight from 500 to 6000, from 500 to 5500, from 500 to 5000, from 500 to 4500, from 500 to 4000, from 500 to 3500, from 500 to 3100, from 500 to 3000, from 500 to 2500, from 500 to 2000, or from 500 to 1500; or a weight average molecular weight from 1000 to 6000, from 1000 to 5500, from 1000 to 5000, from 1000 to 4500, from 1000 to 4000, from 1000 to 3500, from 1000 to 3100, from 1000 to 3000, from 1000 to 2500, from 1000 to 2000, or from 1000 to 1500. As an example, in a preferred embodiment, the tackifying agent may be a lignin-based tackifying agent having a molecular weight no greater than 4000, no greater than 3100, no greater than 3000, no greater than 2900, no greater than 2500, no greater than 2000, or even no greater than 1500; and exhibiting a glass transition temperature from 30° C. to 40° C., from 30° C. to 50° C., from 30° C. to 60° C., from 30° C. to 70° C., from 30° C. to 80° C., from 30° C. to 90° C., from 30° C. to 100° C., from 30° C. to 110° C., or even from 30° C. to 120° C.

In some embodiments, suitable tackifying agents that may be used to form the adhesive composition include those having a softening point at a temperature from about 30° C. to about 160° C., as measured by the ASTM Ring and Ball softening point test. For example, suitable tackifying agents may have a softening point of greater than 30° C. and less than about 160° C., less than about 150° C., or less than about 140° C. In some instances, tackifying agents suitable for use in forming the adhesive composition have a softening point at a temperature from about 60° C., about 80° C., about 100° C., to about 120° C., about 140° C., or about 160° C., or a softening point between any pair of the foregoing temperatures

In some embodiments, the lignin-based tackifying agent is non-hydrogenated. For example, a suitable non-hydrogenated lignin-based tackifying agent will be appreciably aromatic in nature, characterized by having 50 percent or greater of the carbon atoms in the tackifying agent being aromatic (i.e., included in planar rings of atoms joined by covalent bonds with delocalized Pi electrons above and below the plane).

Further tackifying agents that may be included in the adhesive composition include, aromatic, aliphatic and cycloaliphatic hydrocarbon resins, mixed aromatic and aliphatic modified hydrocarbon resins, hydroxyl modified resins, aromatic modified aliphatic hydrocarbon resins, and hydrogenated versions thereof. For example, further suitable examples of tackifying agents that can be included in addition to a lignin-based tackifying agent include bio-based tackifying agents that are not lignin-based, such as rosin based tackifying agents, terpenes, modified terpenes and hydrogenated versions thereof.

In some embodiments, suitable tackifying agents include rosin based tackifying agents, terpene resins, phenolic resins (e.g., terpene phenolic resins, phenol modified aromatic hydrocarbon resins) and hydrogenated version thereof. In some embodiments, suitable tackifying agents include natural rosins, modified rosins, rosin esters, and hydrogenated versions thereof; low molecular weight polylactic acid, and combinations thereof. Examples of suitable natural and modified rosins include gum rosin, wood rosin, tall oil rosin, distilled rosin, hydrogenated rosin, dimerized rosin, and polymerized rosin. Examples of suitable tackifying agents include rosin esters, including glycerol esters of rosin, methyl esters of rosin, glycerol esters of hydrogenated rosin, glycerol esters of polymerized rosin, pentaerythritol esters of natural and modified rosins including pentaerythritol esters of rosin, pentaerythritol esters of hydrogenated rosin, pentaerythritol esters of tall oil rosin, phenolic-modified pentaerythritol esters of rosin, and combinations thereof.

Further examples of suitable tackifying agents include copolymers and terpolymers of natural terpenes, for example, styrene-terpene, alpha-methyl styrene-terpene and vinyl toluene-terpene, and combinations thereof. Examples of suitable aliphatic and cycloaliphatic petroleum hydrocarbon resins include aliphatic and cycloaliphatic petroleum hydrocarbon resins, the hydrogenated derivatives thereof, and combinations thereof. Suitable aliphatic and cycloaliphatic petroleum hydrocarbon resins include, e.g., branched, unbranched, and cyclic C5 resins, C9 resins, and C10 resins.

Examples of suitable commercially available tackifying agents that may be included in the adhesive composition include those available under a variety of trade designations including certain of the ESCOREZ series of trade names (available from ExxonMobil Chemical Co., in Houston, TX) including ESCOREZ 5400, ESCOREZ 5415, ESCOREZ 5600, ESCOREZ 5615, and ESCOREZ 5690, the EASTOTAC series of trade designations (available from Eastman Chemical Co., located in Kingsport, TN) including EASTOTAC H-100R, EASTOTAC H-100L, EASTOTAC H 130W, and EASTOTAC H142, the WINGTACK series of trade designations (available from Cray Valley HSC, in Exton, PA) including WINGTACK 86, WINGTACK EXTRA, and WINGTACK 95, the PICCOTAC series of trade names (available from Eastman Chemical Co.) including PICCOTAC 8095, the ARKON series of trade designations (available from Arkawa Europe GmbH, Germany) including ARKON P-125, and those available under the REGALITE series of trade designations (available from Eastman Chemical Co.) including, e.g., REGALITE R1125.

Suitable commercially available tackifying agents that may be included in the adhesive composition include, phenol modified terpene resins such as those available under the trade designation SYL VARES TP (available from KRATON Corp., in Houston, TX) and phenol modified C9 aromatic hydrocarbon resins such as those available under the trade designation HIKOTACK P (available from Kolon Chemical Company LTD, Kwacheon City, Korea).

In some embodiments, a hot melt adhesive may include a hydroxyl modified tackifying agent (an —OH modified tackifying agent), such as a hydroxyl terminated tackifying agent. In some embodiments, the tackifying agent has a hydroxyl (OH) number from about 1, about 5, about 10, about 15, about 20, about 25, about 30, about 50 to about 100, about 140, about 160, about 200, about 250, about 300, about 380, about 400, or about 420, or an OH value between any pair of the foregoing values

Useful rosin based tackifying agents are commercially available under a variety of trade designations including rosin ester tackifying agents available under the SYLVALITE trade designation (from Kraton Corporation, of Houston, TX, USA) such as SYLVALITE RE 100L and SYLVALITE RE 105L and under the KOMOTAC trade designation (from Guangdong Komo Co. Ltd., of Guangzhou, China) such as KOMOTAC KM-100.

The adhesive composition includes the tackifying agent in an amount from about one %, about five %, about 10%, or about 15%, to about 30%, about 40%, about 50%, about 60%, or about 70%, by weight, based on the total weight of the adhesive composition, or an amount between any pair of the foregoing values. In some embodiments, one or more tackifying agents is present in the adhesive composition, and the combined amount of the one or more tackifying agents is from about one %, about five %, about 10%, or about 15%, to about 30%, about 40%, about 50%, about 60%, or about 70%, by weight, all based on the total weight of the adhesive composition, or an amount between any pair of the foregoing values.

In some embodiments, an adhesive composition includes a lignin-based tackifying agent derived from one kind of lignin in an amount from about one %, about five %, about 10%, or about 15%, to about 30%, about 40%, about 50%, about 60%, or about 70%, by weight, based on the total weight of the adhesive composition, or an amount between any pair of the foregoing values; for example, from 20% to 70%, from 30% to 70%, from 30% to 60%, from 30% to 50%, from 30% to 40%, or even from 40% to 50% by weight. In some embodiments, an adhesive composition includes a lignin-based tackifying agent derived from more than one kind of lignin in an amount from about one %, about five %, about 10%, or about 15%, to about 30%, about 40%, about 50%, about 60%, or about 70%, by weight, based on the total weight of the adhesive composition, or an amount between any pair of the foregoing values. In some embodiments, an adhesive composition includes two or more lignin-based tackifying agents and the combined amount of the two or more lignin based tackifying agents is an amount from about one %, about five %, about 10%, or about 15%, to about 30%, about 40%, about 50%, about 60%, or about 70%, by weight, based on the total weight of the adhesive composition, or an amount between any pair of the foregoing values. In some embodiments, an adhesive composition includes one or more lignin-based tackifying agents and one or more non-lignin-based tackifying agents, and the combined amount of all the tackifying agents is an amount from about one %, about five %, about 10%, or about 15%, to about 30%, about 40%, about 50%, about 60%, or about 70%, by weight, based on the total weight of the adhesive composition, or an amount between any pair of the foregoing values.

### Polymer

The adhesive composition includes a polymer. Suitable polymers that can be included in the adhesive composition include thermoplastic polymers. For example, the adhesive composition can include one or more thermoplastic polymers which combine with the remaining components of the adhesive composition to provide initial green strength to the adhesive composition. For example, the adhesive composition can include one or more thermoplastic polymers suitable with a lignin-based tackifying agent to form a hot melt adhesive composition.

In some embodiments, suitable polymers include those derived from renewable resources (e.g. plants). For example, polymers derived from plant sources, such as polylactic acid, can be formed from bio-produced monomers, and can be used to make a bio-based polymer. A bio-produced monomer is defined as a monomer derived from a bio-based source, for example a plant, such as corn or soybeans. Bio-produced monomers are commonly derived from the components of plant material such as cellulose, starch, and sugars such as glucose. It is anticipated that polymers made with bio-produced monomers will exhibit similar properties to those made with petroleum derived monomers that have similar characteristics. Bio-produced monomers can be selected from ethylene, propylene, isoprene, butadiene, and styrene. However, useful bio-produced monomers are not restricted to this group.

In some embodiments, suitable polymers include those derived from non-renewable resources (e.g. petroleum, or synthetic polymers derived from coal). Suitable polymers may exclude emulsion and aqueous polymers.

In some embodiments, the polymer is at least one of a homopolymer, copolymer or a higher order polymer. For example, the polymer may be a block copolymer and/or a terpolymer In some embodiments, the polymer can be an elastomer.

In some embodiments, the polymer has a melt flow index greater than one, greater than five, greater than 20, or even greater than 30. For example, suitable polymers may include those having a melt flow index from 30, 40, 50, 100, 200, or 300 to about 400, 500, 600, 700, 800, 900, or even 1000, or a melt flow index between any pair of the foregoing values. For example, preferred polymers may include those having a melt flow index from 30 to 1000, from 30 to 900, from 30 to 800, from 30 to 700, from 30 to 600, from 30 to 500, from 30 to 400, from 30 to 300, from 30 to 200, from 30 to 100, from 30 to 90, from 30 to 80, from 30 to 50, or from 30 to 40.

In some embodiments, the thermoplastic polymer exhibits a glass transition temperature less than 80° C. For example, polylactic acid may have a glass transition temperature from about 50° C., or about 60° C., to about 70° C., or even about 80° C. In some embodiments, the thermoplastic polymer has a glass transition temperature less than 10° C., less than 0° C., less than −10° C., or even less than −20° C. For example, metallocene catalyzed polyethylene may have a glass transition temperature less than −50° C., for example about −58° C. A polypropylene copolymer may have a glass transition temperature less than −10° C., for example from about −18° C. to about −40° C. A polypropylene homopolymer may have a glass transition temperature less than 0° C., for example about −9° C.

In some embodiments, suitable polymers include, but are not limited to, block copolymers such as A-B diblock copolymers, A-B-A triblock copolymers, radial A-B-type block copolymers, multiblock copolymers, Y block copolymers, linear A-(B-A)ₙ-B block copolymer, or an amorphous or semi-crystalline polyolefin polymer.

In some embodiments, such as an A-B-A block copolymer, a radial A-B-type block copolymer, or a linear A-(B-A)ₙ-B block copolymer, the A component may comprise a polystyrene block and the B component may comprise a rubbery block, such as a polyolefin block. Further suitable A components include polymers that have aromatic monomers and glassy end block units, and other similar polymers. Suitable B components include, but are not limited to, polymers or monomers that can generate rubbery polymeric blocks such as isoprene, butadiene, and mixtures thereof. Suitable B components may include hydrogenated and/or nonhydrogenated polymers or monomers. Suitable block copolymers may include styrene block copolymers, including but not limited to, styrene-ethylene-butylene-styrene (SEBS), styrene-isoprene-styrene (SIS), styrene-butadiene-styrene (SBS), styrene-butadiene rubber (SBR), or hydrogenated SIS (SEPS), and combinations thereof.

Suitable block copolymers may include styrene block copolymers containing styrene in an amount of about 10%, about 15%, or about 20%, to about 40%, about 45%, or about 50% by weight, based on the total weight of the block copolymer, or a weight percent between any pair of the foregoing values. Suitable examples of block copolymers may include styrene-isoprene-styrene (SIS) block copolymers having a number average molecular weight of from about 50,000, about 70,000, or about 90,000, to about 150,000, about 180,000, about 200,000, or about 500,000, and containing from about 10%, about 15%, or about 20%, to about 40%, about 50%, or about 60% styrene, by weight, based on the total weight of the copolymer. Further suitable examples of block copolymers may include styrene-butadiene-styrene (SBS) block copolymers having a molecular weight of about 50,000, about 70,000, or about 90,000, to about 150,000, about 180,000, or about 200,000, or about 500,000, and from about 10%, about 15%, or about 20%, to about 40%, about 50%, or about 60% by weight styrene, based on the total weight of the block copolymer, or a weight percent between any pair of the foregoing values. Further suitable examples of block copolymers may include styrene hydrogenated butadiene styrene block copolymers (i.e. styrene-ethylene-butylene-styrene block copolymers) having a molecular weight of about 30,000, about 50,000, or about 70,000, to about 90,000, about 100,000, or about 120,000, or about 500,000, and from about 10%, about 15%, or about 20%, to about 40%, about 50%, or about 60% by weight styrene, based on the total weight of the block polymer, or a weight percent between any pair of the foregoing values. In some embodiments, the polymer may include a mixture of copolymers having a ratio of di-block polymer to tri-block polymers from about 0.1:1, about 0.2.1, about 0.3:1, to about 0.8:1, about 0.9:1, or about 1:1, or a ratio between any pair of the foregoing values, or even greater than 1:1.

Further examples of suitable polymers may include polybutadienes, including the hydroxylated versions thereof, for example hydroxyl-terminated polybutadiene. Further examples of other suitable thermoplastic polymers include polyolefins. For example, the thermoplastic polymer may be at least one of a propylene-rich polyolefin, a butene-rich polyolefin, or an ethylene-rich polyolefin.

In some preferred embodiments, suitable polymers include acrylates or acetates, for example, ethylene-vinyl acetate (EVA), polar ethylene polymers, such as ethyl n-butyl acrylate, ethylene n-butyl acrylate carbon monoxide terpolymers. For example, a suitable polymer may include EVA having a vinyl acetate content of at least 25%, at least 28%, at least 30%, at least 33%, or even at least 35%, based on the total weight of the polymer. In some embodiments, suitable thermoplastic polymers may include EVA having a weight average molecular weight of from 18,000, about 50,000, about 70,000, or about 90,000, to about 150,000, about 180,000, or about 200,000, or about 500,000, or a molecular weight between any pair of the foregoing values.

In some embodiments, a suitable polymer may include EVA having a vinyl acetate content of at least 14%, at least 18%, at least 20%, at least 25%, or even at least 28%, based on the total weight of the polymer. For example, an adhesive composition that includes a hydrogenated tackifying agent, a suitable polymer may include EVA having a vinyl acetate content of at least 14%, at least 18%, at least 20%, at least 25%, or even at least 28%, based on the total weight of the polymer. In some embodiments, for an adhesive composition that includes a hydrogenated tackifying agent, a suitable polymer may be a polyethylene or for instance, a polypropylene, for example a single site (e.g., metallocene) catalyzed polyethylene, or metallocene catalyzed polypropylene

Examples of suitable commercially available thermoplastic polymers include styrene block copolymers such as those available under the trade designation SIS 1105 or SIS 1124 (both available from Guangzhou Tongshen Chemical Co., located in Guangzhou City, China), KRATON D1126 or other styrene block copolymers available under the trade designation KRATON and KRATON G (available from Kraton Corp., located in Houston, TX, USA). Examples of suitable olefin block copolymers include those available under the trade designation INFUSE (available from The Dow Chemical Co, located in Midland, MI). Examples of suitable propylene-rich polyolefins include those available under the trade designation VISTAMAXX 6202 (available from ExxonMobil Chemical Company, of Houston, TX). Suitable examples of m-PE polymers (metallocene catalyzed polyethylene copolymer) that may be used in an adhesive composition include those available under the trade designation AFFINITY 1950 (from Dow Chemical Company of Midland, MI).

Suitable adhesive compositions include a polymer in an amount from about five %, about 10%, about 15%, about 20%, or about 25%, to about 50%, about 55%, about 60%, about 65%, or about 70% by weight, based on the total weight of the adhesive composition, or an amount between any pair of the foregoing values. For example, in some embodiments, an adhesive composition includes a thermoplastic polymer in an amount from about five %, about 10%, about 15%, about 20%, or about 25%, to about 50%, about 55%, about 60%, about 65%, or about 70% by weight, based on the total weight of the adhesive composition, or an amount between any pair of the foregoing values, for example, from 20% to 70%, from 20% to 60%, from 20% to 50%, from 20% to 40%, from 30% to 70%, from 30% to 60%, from 30% to 50%, from 30% to 40%, from 40% to 70%, from 40% to 60%, from 40% to 50%, or even from 35% to 45%. In embodiments having more than one polymer, the total amount of the more than one polymer in the adhesive composition may be from about five %, about 10%, about 15%, about 20%, or about 25%, to about 50%, about 55%, about 60%, about 65%, or about 70% by weight, based on the total weight of the adhesive composition, or an amount between any pair of the foregoing values.

### Wax

In some embodiments, the adhesive composition includes wax. For example, the adhesive composition can include a paraffin wax (e.g., waxes derived from crude oil), microcrystalline, or synthetic wax. Additionally, or alternatively, the adhesive composition can include waxes such as a fatty amide wax, or a Fischer-Tropsch wax (produced by Fischer-Tropsch synthesis including, e.g., a catalyzed chemical reaction in which synthesis gas (i.e., syngas), a mixture of carbon monoxide and hydrogen, is converted into liquid hydrocarbons of various lengths), e.g., an oxidized Fischer-Tropsch wax. The wax can be a bio-based material. In some embodiments, the adhesive composition can include a combination of waxes. For example, the adhesive composition may include a combination of two or more synthetic waxes. In some embodiments, two or more waxes, such as a blend of paraffin and Fischer-Tropsch wax can help give an adhesive composition a low viscosity at the application temperature and a fast rate of set.

In some embodiments, useful paraffin waxes contain from about 40% to about 90% of normal alkanes and contain less than about 3.0% by weight oil, or even less 10 than about 2.0% by weight oil. Useful paraffin waxes may have a congealing point of greater than about 60° C., greater than about 62° C., or even from about 60° C. to about 75° C. Useful commercially available paraffin waxes include e.g , FR-6513 from Citgo Petroleum (Houston, TX) and SASOLWAX 6705 from Sasol Performance Chemicals (Hamburg, Germany).

In some embodiments, useful Fischer-Tropsch waxes have a congealing point of no greater than about 95° C., or no greater than about 90° C.; for example, between about 65° C. and 95° C., or between about 65° C. and 90° C.

Useful commercially available Fischer-Tropsch waxes include for example, those available under the trade designations SARAWAX SX-70, SX-80, or SX-105 from Shell MDS (Bintulu, Malaysia; available from EVONIK OPERATIONS, GmbH); and SASOLWAX C-80, Fischer-Tropsch wax from Sasol Performance Chemicals (Hamburg, Germany).

In some embodiments, a wax may be included in the adhesive composition in an amount from one %, two %, five %, 10%, 15%, or 20%, to 30%, 35%, 40% or 45%, by weight, based on the total weight of the adhesive composition; for example, from about five % by weight to about 40% by weight, from about 10% by weight to about 35% by weight, or even from about 10% by weight to about 20% by weight.

### Plasticizer

In some embodiment, the adhesive composition can include one or more plasticizers. In some embodiments, the plasticizer is at least one of an oil, a liquid resin, or a liquid polymer. Liquid resins include resins that are liquid at room temperature (e.g., from about 25° C. to about 35° C.). The plasticizer can be a bio-based material. In some embodiments, suitable plasticizers for use in forming the adhesive composition include, mineral oils, paraffin oils, naphthenic oils, synthetic liquid oligomers of polyolefins (e.g., polybutene and polypropylene), triglycerides, liquid polyisobutylene, polyesters, hydrocarbon fluids, crop oils such as vegetable oils, and combinations thereof. In some embodiments, a suitable plasticizer may have number average molecular weight (Mn) from about 1,000, about 2,000 to about 6,000 or about 10,000, or a molecular weight between any pair of the foregoing values.

### Antioxidant

For example, in some embodiments, the adhesive composition includes one or more antioxidant. In some embodiments, suitable antioxidants include but are not limited to pentaerythritol tetrakis[3,(3,5-di-tert-butyl-4-hydroxyphenyl)propionate], 2,2′-methylene bis(4-methyl-6-tert-butylphenol), phosphites including, e.g., tris-(p-nonylphenyl)-phosphite (TNPP) and bis(2,4-di-tert-butylphenyl)4,4′-diphenylene-diphosphonite, di-stearyl-3,3′-thiodipropionate (DSTDP), and combinations thereof. Useful antioxidants are commercially available under a variety of trade designations including, for example, hindered phenolic antioxidants available under the IRGANOX® series of trade designations (available from BASF Corporation, Florham Park, N.J.) including, e.g., IRGANOX 1010, IRGANOX 565, IRGANOX 1076, phosphite antioxidants available under the trade designation IRGAFOS® such as IRGAFOS® 168 (available from BASF, of Ludwigshafen, Germany) and 4,4′-methylene bis(2,6-di-tert-butylphenol) available under the common name Ethyl 702.

### Additional Components

In some embodiments, the adhesive composition optionally includes one or more of a variety of additional components including, for example, stabilizers, adhesion promoters, ultraviolet light stabilizers, rheology modifiers, biocides, corrosion inhibitors, dehydrators, colorants (e.g., pigments and dyes), fillers, surfactants, flame retardants, waxes, additional polymers, and mixtures and combinations thereof.

As an example, an asphaltic adhesive can include petroleum-based components such as asphalt, coal-tar, bitumen, for example, virgin bitumen, recycled bitumen, or combinations thereof For example, an asphaltic adhesive may include a petroleum-based component such as bitumen, a lignin-based tackifying agent, optionally an elastomer (e.g., butyl or EPDM rubber), and optionally an oil.

### Hot Melt Adhesive Composition

In some embodiments, forming an adhesive composition includes combining the polymer, tackifying agent, and any other suitable components to form the adhesive composition. In some embodiments, forming a hot melt adhesive composition includes combining the polymer, tackifying agent, and any other suitable components at an elevated temperature to form a hot melt adhesive composition. For example, a method of forming a hot melt adhesive composition may include combining the polymer, tackifying agent, and any other suitable components, with the amount of each component forming a hot melt adhesive composition exhibiting suitable characteristics.

In some embodiments, the adhesive composition exhibits a softening point at a temperature no greater than 160° C., no greater than 150° C., no greater than 145° C., no greater than 135° C., no greater than 130° C., no greater than 125° C., no greater than 120° C., no greater than 115° C., no greater than 110° C., no greater than 105° C., no greater than 100° C., no greater than 90° C., or even no greater than 80° C.

In some embodiments, an adhesive composition including a wax exhibits a viscosity of no greater than no greater than 10,000 cP, at a temperature of about 177° C. (e.g., from 177° C. to 178° C.) In some embodiments, a suitable adhesive composition exhibits a viscosity of no greater than 10,000 cP, no greater than 9,000 cP, no greater than 8,000 cP, no greater than 7,000 cP, no greater than 6,000 cP, no greater than 5,000 cP, no greater than 4,000 cP, no greater than 3,000 cP, no greater than 2,000 cP, or even no greater than 1,500 cP, at a temperature of about 177° C. For example, a suitable hot melt adhesive may exhibit a viscosity from about 1000 cP, about 1,500 cP, about 2000 cP, about 2,500 cP, or about 3000 cP, to about 3500 cP, about 4,000 cP, about 4500 cP, about 5,000 cP, about 6,000 cP, about 7,000 cP, or even about 8,000 cP, at a temperature of about 177° C.

In some embodiments, an adhesive composition that does not include a wax exhibits a viscosity of no greater than no greater than 100,000 cP, at a temperature of about 177° C. (e.g., from 177° C. to 178° C.)

In some embodiments, a suitable adhesive composition exhibits a viscosity of no greater than 100,000 cP, no greater than 90,000 cP, no greater than 80,000 cP, no greater than 70,000 cP, no greater than 60,000 cP, no greater than 50,000 cP, no greater than 40,000 cP, no greater than 30,000 cP, no greater than 20,000 cP, or even no greater than 15,000 cP, at a temperature of about 177° C. For example, a suitable hot melt adhesive may exhibit a viscosity from about 10,000 cP, about 15,000 cP, about 20,000 cP, about 25,000 cP, or about 30,000 cP, to about 35,000 cP, about 40,000 cP, about 45,000 cP, about 50,000 cP, about 60,000 cP, about 70,000 cP, or even about 80,000 cP, at a temperature of about 177° C.

### Renewable Resources

With dwindling reserves of petroleum or other fossil fuel sources, there is a growing interest in identifying renewable resources for providing raw materials in a variety of industries. Generally, a renewable resource can be replenished naturally or by engineered agricultural techniques. Examples of renewable resources include but are not limited to plants (e.g., sugar cane, beets, corn, potatoes, citrus fruit (e.g., oranges), and forestry products (e.g., pine and spruce trees), woody plants, cellulosic waste), animals, fish, bacteria, and fungi. These resources can be naturally occurring, hybrids, or genetically engineered organisms As used herein, resources such as crude oil, coal and natural gas are not considered renewable as they are derived from materials that will run out or will not be replenished for thousands or even millions of years.

The term bio-based product generally refers to products wholly or partly derived from biomass, such as plants, trees or animals (the biomass can have undergone physical, chemical or biological treatment). It does not include petroleum derived products. To determine whether a material has come from a bio-based product, the number of neutrons in the carbon atoms of the material can be measured. For example, atoms of carbon-14 (C14) have eight neutrons, whereas atoms of carbon-12 (C12) have six neutrons. Carbon in petroleum derived material has a lower percentage of C14 to C12. The ratio of C14 to C12 is indicative of the source of a carbon-containing material.

One technique for assessing whether a material has come from a renewable resource is to assess the amount of biogenic carbon contained in the material. The percent biogenic carbon in a material indicates the percentage carbon from renewable resources (e.g., plants, biomass, or animal by-products) versus petroleum (or otherwise fossil) sources. The fraction or percent of the material that is made up of biogenic carbon can be determined by measuring the radiocarbon to determine the carbon-14 (C14) content of the material. A material that is determined to have 100% biogenic carbon indicates that the material was sourced completely from a renewable resource Conversely, a material that is determined to contain zero % biogenic carbon indicates that the material does not contain carbon from a renewable resource.

A test to identify the percent biogenic carbon in a material includes measuring the C14 content of the material and comparing it to a modern reference standard, such as those commercially available (such as through NIST, SRM 4990C (Standard Reference Materials for Radioactivity Measurements, July 2009)).

### Lignin-Based Tackifying Agents

Lignin from biomass presents a potential substitute as a raw material for components based on non-renewable resources. Lignin can be used in addition to, or as an alternative to, other components based on renewable resources, to help provide options and various feed sources for those wishing to avoid using non-renewable resources.

Plant material (e.g., cell walls) are made up of lignocellulose, which contains three polymeric components: cellulose, hemicellulose, and lignin. In the plant material, the lignin holds the cellulose and hemicellulose together. Cellulose is a linear glucose polysaccharide and forms the main constituent of plant cell walls. Hemicellulose is a cross-linked polysaccharide with a simpler structure than that of cellulose.

The woody parts of trees and certain other plants have a secondary cell wall that contains another polymeric material called lignin. Lignin binds the cells fibers and vessels that form wood and bark and lends rigidity to these materials. Lignin is formed by cross-linked phenolic precursors that form polymers. Lignin is a highly non-regular polymer that includes phenol sub-units. Because of the aromatic subunits that form lignin, it is hydrophobic. When it is buried so that it cannot react with oxygen, and is subject to heat and pressure, its structure will eventually condense and form coal

Generally, there are three main kinds of alcohol monomers that form lignin polymers. Coniferyl alcohol is 4-hydroxy-3-methoxyphenylpropane Sinapyl alcohol is 3,5-dimethoxy-4-hydroxyphenylpropane. The radical of sinapyl alcohol is sometimes called syringyl. Paracoumaryl alcohol is 4-hydroxyphenylpropane. The relative amounts of these three kinds of alcohol monomers are determined by the plant source, and lignin can be classified by the relative amounts of these three kinds of alcohol monomers. Hardwood and grass lignins are rich in coniferyl and sinapyl units Softwood lignin is right in coniferyl units.

To purify and separate plant material into the desired components, various processes have been developed to first break down the plant material. One process is to gasify the cellulose in the lignocellulose into carbon monoxide and hydrogen. The gases are converted into bioethanol by fermentation or chemical catalysis. A process to generate useful material from lignin is described in U.S. Pat. No. 10,253,131, the disclosure of which is incorporated herein by reference in its entirety to the extent it does not conflict. A process to depolymerize lignocellulosic biomass is described in International Patent Application Number PCT/US2020/046384 (publication number WO/2021/030690), the disclosure of which is incorporated herein by reference in its entirety to the extent it does not conflict.

### Hot Melt Adhesive That Includes a Hydrogenated Lignin-Based Tackifying Agent

In some embodiments, the hot melt adhesive can include a hydrogenated tackifying agent derived from depolymerized lignin. In some embodiments, a suitable hydrogenated lignin-based tackifying agent exhibits an increased aliphatic carbon content as compared to a non-hydrogenated lignin-based tackifying agent. For example, a suitable hydrogenated lignin-based tackifying agent will be appreciably aliphatic in nature, characterized by having less than 50 percent of the carbon atoms in the tackifying agent being aromatic (i.e., included in planar rings of atoms joined by covalent bonds with delocalized Pi electrons above and below the plane).

A tackifying agent that is appreciably aliphatic in nature would exhibit compatibility with EVA polymers with 28% VA or less, single site catalyzed polyethylene and polypropylene homopolymers and copolymers, as well as the rubbery mid-block of styrenic block copolymers.

As an example, an adhesive composition may include about 45% by weight a hydrogenated lignin tackifier having a glass transition temperature from about 45° C. to 55° C., a number average molecular weight (Mn) of about 800 to 1200 and/or a weight average molecular weight (Mw) of about 2200 to about 2700; about 35% by weight a m-PE polymer (a metallocene catalyzed polyethylene copolymer) such as AFFINITY 1950 (from Dow Chemical Company); and about 20% by weight a synthetic wax (such as SX-105 from Shell MDS). Such a composition is envisioned to have a set speed of less than 1.5 seconds, a PAFT (peel adhesion failure temperature) of greater than 40° C., a SAFT (shear adhesion failure temperature) of greater than 90° C., and good adhesion (characterized as greater than 80% fiber tear) to corrugated board stock at room temperature.

Useful tackifying agents of lignin-based material have been identified. In some instances, suitable tackifying agents can be obtained from lignin-based material having certain properties. Tackifying agents derived from depolymerized lignin and having identified characteristics have been included in adhesive compositions and found to be suitable as hot melt adhesive.

The adhesive compositions disclosed herein can be used in many different applications and for a variety of end uses including various adhesives (e.g., removable and permanent types), bookbinding adhesives, adhesives to attach inserts to published materials (e.g., magazines), adhesives to assemble various items (e.g., filters), adhesives for packaging constructions (e.g., cases, cartons, trays), adhesives for tapes and labels, wood bonding applications including, but not limited to furniture (e.g., edge banding, profile wrapping), asphaltic compositions and adhesives for disposable articles.

The adhesive compositions are suitable for the formation of packaging constructions including, e.g., bags, boxes (e.g., beverage (e.g., beer, soda), and cereal boxes), cartons, cases (e.g., carrying cases), trays, and combinations thereof, and sealing applications including, e.g., case and carton sealing.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above-described features.

### EXAMPLES

The following non-limiting examples are included to further illustrate various embodiments of the instant disclosure and do not limit the scope of the instant disclosure.

### Test Procedures

Test procedures used in the examples include the following.

### Viscosity Test Method

Viscosity is determined in accordance with ASTM D-3236 entitled, “Standard Test Method for Apparent Viscosity of Hot Melt Adhesives and Coating Materials,” (Oct. 31, 1988). Melt viscosities are determined on a Brookfield Thermosel Viscometer Model DV 2T (from AMETEK Brookfield, in Middleboro, MA, USA) using an S27 spindle and reported in centipoise (cP).

### Molecular Weight Test Method for Lignin

Size-exclusion chromatography (SEC) in tetrahydrofuran (THF) is used to measure the molecular weight of depolymerized lignin. The procedure is as follows.

Approximately 0.03 grams of each sample to be measured is mixed with 10 mL THF on a shaker for several hours at room temperature. The resulting solution of the sample to be tested and THE is filtered through a 0.45 μm PTFE filter. Size-exclusion chromatography (SEC) is performed on a high-pressure liquid chromatography (HPLC) instrument (available under the trade designation Waters™ Alliance 2695 HPLC, from Waters Corp. of Milford, MA) at a flow rate of one (1) mL/min with THE as the eluent using three columns (Waters™ Styragel HR1 300 ×7.8 mm, from Waters Corp.) at 40° C. The sample to be measured is analyzed by a first detector (Waters™ 2487 Dual Absorbance detector (at 254 nm and 300 nm)), then analyzed by a second detector (Waters™ 2414 refractive index (RI) detector)) at 40° C., and calibrated to polystyrene standards (molecular weight=0.371−9.59 kDa, using a standard calibration test (available under the trade designation Easi Vial polystyrene PS-L, from Agilent Technologies, Inc. of Santa Clara, CA).

### Glass Transition Temperature Test Method

The glass transition temperature is measured with a differential scanning calorimeter and the temperature is increased at a rate of 15° C. per minute. The numerical value of the glass transition temperature is taken during the third temperature cycle.

### Peel Adhesion Failure Temperature (“PAFT”) Test Method

Peel adhesion failure temperature (PAFT) is determined as follows. A first side of a sample is prepared by affixing two release liners on a first surface of a first substrate (sheet of kraft paper). The release liners are separated from each other by a space of 2.54 cm to form a 2.54 cm channel therebetween, to position the adhesive composition to be tested. A layer of adhesive to be tested is applied to the channel near the top edge of the first substrate.

A second substrate (sheet of kraft paper) is used to form a second side of the sample. The second substrate is positioned against the adhesive layer positioned on the first substrate. A draw down bar is pressed against a first edge of the second substrate, the adhesive layer, and the first substrate, and then drawn down the length of the second substrate from the first edge to an opposing second edge of the second substrate to bond the first substrate to the second substrate through a strip of the adhesive composition. The draw down bar has a gap, which defines the thickness of the adhesive composition in the channel as the bar is drawn down the length of the two substrates that form the two sides of the sample. The resulting strip of adhesive layer is 2.54 cm (one inch) wide and from 0.2 mm to 0.3 mm (from eight mils to 12 mils) thick. The first and second substrate are cut across the width of the strip of adhesive to form samples, each sample having an area of 6.45 cm² (one inch by one inch) bonded by the adhesive to the tested.

The sample is conditioned at room temperature for at least 12 hours. The sample is positioned in an oven in the peel mode such that the top edge of the first substrate is held in position in the oven by a clamp, and a 100-gram weight is attached to the top edge of the second substrate. The ambient temperature in the oven is increased from a starting temperature of 25° C. to a final temperature of 140° C. at a rate of 25° C. per hour. Failure is when the first substrate separates from the second substrate. The oven automatically records the temperature at which the sample fails. A minimum of five samples are run for each sample composition. The average PAFT value of the five samples is reported in degrees Celsius.

### Shear Adhesion Failure Temperature (“SAFT”) Test Method

Shear adhesion failure temperature (SAFT) is determined as follows. A first side of a sample is prepared by affixing two release liners on a first surface of a first substrate (sheet of kraft paper). The release liners are separated from each other by a space of 2.54 cm to form a 2.54 cm channel therebetween, to later position the adhesive composition to be tested A layer of adhesive to be tested is applied to the channel near the top edge of the first substrate.

A second substrate (sheet of kraft paper) is used to form a second side of the sample. The second substrate is positioned against the adhesive layer positioned on the first substrate. A draw down bar is pressed against a first edge of the second substrate, the adhesive layer, and the first substrate, and then drawn down the length of the second substrate from the first edge to an opposing second edge of the second substrate to bond the first substrate to the second substrate through a strip of the adhesive composition. The draw down bar has a gap, which defines the thickness of the adhesive composition in the channel as the bar is drawn down the length of the two substrates that form the two sides of the sample. The resulting strip of adhesive layer is 2.54 cm (one inch) wide and from 0.2 mm to 0.3 mm (from eight mils to 12 mils) thick. The first and second substrate are cut across the width of the strip of adhesive to form samples, each sample having an area of 6.45 cm² (one inch by one inch) bonded by the adhesive to the tested.

The sample is then positioned in an oven such that the top edge of the first substrate is held in position in the oven by a clamp, and a 500-gram weight is suspended from the second substrate of each sample in the shear mode, i.e., the weight is attached to the lower edge of the second substrate. The ambient temperature in the oven is increased from a starting temperature of 25° C. to a final temperature of 140° C. at a rate of 25° C. per hour. Failure is when the first substrate separates from the second substrate. The oven automatically records the temperature at which the samples fail. A minimum of three samples are run for each sample composition. The average SAFT value of the three samples is reported in degrees Celsius.

### Set Time Test Method

The Set Time Test Method is used to measure the set time of the adhesive. Set time is the amount of time required to achieve greater than 80% fiber tear after two substrates which have been previously bonded together through the adhesive to be tested, are separated by force. The Set Time Test is carried out as follows.

The adhesive to be tested is applied at 175° C. to form a bead having a width of 3/32 inches using a MiniSquirt III hot melt applicator system commercially available from Nordson (of Westlake, OH, USA). The bead of adhesive is applied to a first substrate and then a bond to a second substrate is made by contacting the bead of adhesive to the second substrate to form a test sample. The substrate is 44-pound edge crush C flute corrugated linear board (available from WestRock Company, of Atlanta, GA, USA). The bead of adhesive is contacted to the second substrate less than two seconds after the adhesive to be tested is applied to the first substrate and enough force is applied to the substrates to slightly compress the flutes.

The substrates of each test sample are manually pulled apart from each other one second after they are joined together through the adhesive to be tested. A visual inspection is used to measure the surface of the area of the adhesive that is covered by fiber, and to give a value of percent fiber tear. If 80% fiber tear is achieved, the set time is recorded as one second. If 80% fiber tear is not achieved, the test is repeated with 1.5 seconds between joining the substrates and pulling them apart. This cycle continues with 0.5 second increases in the wait time between mating and pulling until 80% fiber tear is achieved. The set time is recorded as the minimum amount of time required to achieve 80% fiber tear.

### Fiber Tear Test Method

The Fiber Tear Test Method is used to measure fiber tear. Fiber tear is the percentage of the surface of the area of the adhesive that is covered by fiber after two substrates, which have been previously bonded together through the adhesive to be tested, are separated by force The Fiber Tear Test is carried out as follows.

The adhesive to be tested is applied at 175° C. to form a bead having a width of 3/32 inches using a MiniSquirt III hot melt applicator system commercially available from Nordson (of Westlake, OH). The bead of adhesive is applied to a first substrate and then a bond to a second substrate is made by contacting the bead of adhesive to the second substrate to form a test sample. The bead of adhesive is contacted to the second substrate less than two seconds after the adhesive to be tested is applied to the first substrate. The substrate is 44-pound edge crush C flute corrugated linear board (available from WestRock Company, of Atlanta, GA, USA).

Test samples of the bonded substrates are each stored at specific temperatures (−18° C., 4° C., 23° C., 54° C.) for around 24 hours. Five samples are tested at each temperature condition.

The substrates of each test sample are manually pulled apart from each other. A visual inspection is used to measure the surface of the area of the adhesive that is covered by fiber, and to give a value of percent fiber tear. The measured result is the average of the five test samples conditioned at each temperature.

### Bond Strength Test Method

The Bond Strength Test is used to measure adhesive bond strength. The Bond Strength Test is carried out as follows.

The adhesive to be tested is applied to a first substrate (1.3 cm (0.5 inch) thick particle board) to form a layer of adhesive one millimeter (+0.1 mm) thick and then the adhesive layer is contacted to a second substrate (PVC film) with 0.7 kilopascals (0.1 psi) of pressure at a temperature of 160° C. for 15 seconds. Care is taken to make sure the PVC films are not distorted by the heat. The first substrate is separated from the second substrate at separation rate of 15 cm/min in a 90° peel mode (i.e., with the first substrate oriented at a 90° angle from the second substrate, such that the adhesive bond is pulled from the second substrate at an angle normal to the bonded surface of the second substrate). Three samples are tested to obtain the average 90° peel adhesive bond strength value.

### Softening Point Test Method

The Softening Point Test Method is carried out as described in D3461-18 titled “Standard Test Method for Softening Point of Asphalt and Pitch (Mettler Cup-and-Ball Method) using an instrument (DP70 Dropping Point System from Mettler Toledo LLC of Columbus, OH). All samples to be tested are measured twice and the average value listed.

### RESULTS

Experimental samples of hot melt adhesives were formed. The compositions used to form innovative samples and control samples are included in Table 1. The measured values of the Fiber Tear Test and the Bond Test for the samples are listed in Table 1.

The polymer A was 33% VA, EVA (melt index of 400 (ATEVA 3342, available from Celanese Corp. of Dallas, TX, USA)). The polymer B was 28% VA, EVA (melt index of 800 (ATEVA 2850A, available from Celanese Corp.)).

The lignin-based tackifying agent was depolymerized softwood lignin (from Lignolix, Inc. of Wilmington, DE, USA). The depolymerized lignin exhibited a glass transition temperature within the range of from 30° C. to 70° C. and a reported weight average molecular weight less than 3000. The rosin ester based tackifying agent was WESTREZ 5101 (from Ingevity, of North Charleston, S.C., USA). The wax was Fischer-Tropsch hard paraffin (Sarawax SX-105, from Shell, of Houston, TX, USA). The antioxidant was IRGANOX 1010 (available from BASF, of Florham Park, NJ, USA).

In Bond Strength Test 1, substrate I was particle board, and substrate 2 was polyvinyl chloride (PVC) film (12 mil. PVC film, creamy white, available under the trade designation MLA, from American RENOLIT Corporation, La Porte, IN USA). In Bond Strength Test 2, substrate 1 was particle board and substrate 2 was PVC film (seven mil. PVC film, creamy white, available under the trade designation IN SEASONED OAK, from American RENOLIT Corporation).

TABLE 1
Experimental Results

| | Sample 1 | Sample 2 | Sample 3 | Sample 4 | Sample 5 | Control 1 |
|---|---|---|---|---|---|---|
| Polymer A | 40 | 35 | 55 | | 40 | 40 |
| (wt. %) | | | | | | |
| Polymer B | | | | 55 | | |
| (wt. %) | | | | | | |
| Lignin Based | 35 | 45 | 44 | 44 | 35 | |
| Tackifying | | | | | | |
| Agent (wt. %) | | | | | | |
| Rosin ester | | | | | | 35 |
| based | | | | | | |
| tackifying | | | | | | |
| agent (wt. %) | | | | | | |
| Wax (wt. %) | 24.5 | 19.5 | | | 24.5 | 24.5 |
| Antioxidant | 0.5 | 0.5 | 1.0 | 1.0 | 0.5 | 0.5 |
| (wt. %) | | | | | | |
| Viscosity (cP) | 3700 | 4865 | 71,000 | 34,700 | 3915 | 1105 |
| at 177° C. | | | | | | |
| (350° F.) | | | | | | |
| % Fiber Tear | 100% | 100% | | | 78% | 88% |
| Test Result | | | | | | |
| (24 hrs at- | | | | | | |
| 18° C.) | | | | | | |
| % Fiber Tear | 90% | 90% | | | 93% | 92.5% |
| Test Result | | | | | | |
| (24 hrs at 4° C.) | | | | | | |
| % Fiber Tear | 57% | 83% | | | 87.5% | 100% |
| Test Result | | | | | | |
| (24 hrs at | | | | | | |
| 23° C.) | | | | | | |
| % Fiber Tear | 87% | 74% | | | 89% | 100% |
| Test Result | | | | | | |
| (24 hrs at | | | | | | |
| 54° C.) | | | | | | |
| Bond Strength | | | 3.45 N/cm | 2.85 N/cm | | |
| Test 1 Result | | | (1.97 | (1.63 | | |
| | | | lbf/inch) | lbf/inch) | | |
| Bond Strength | | | 3.64 N/cm | 1.35 N/cm | | |
| Test 2 Result | | | (2.08 | (0.77 | | |
| | | | lbf/inch) | lbf/inch) | | |
| Softening | 117.7° C. | | | 103.3° C. | | |
| Point | (243.9° F.) | | | (217.9° F.) | | |

1. An adhesive composition comprising:
a lignin-based tackifying agent exhibiting a glass transition temperature from 30° C. to 120° C.; and
a thermoplastic polymer;
wherein the adhesive composition exhibits a softening point at a temperature below 160° C.

2. The adhesive composition of claim 1, wherein the lignin-based tackifying agent has a weight average molecular weight of no greater than 6000.

3. The adhesive composition of claim 1, wherein the lignin-based tackifying agent has a weight average molecular weight of no greater than 4000.

4. The adhesive composition of claim 1, wherein the lignin-based tackifying agent has a weight average molecular weight of no greater than 3000.

5. The adhesive composition of claim 1, wherein the lignin-based tackifying agent exhibits a glass transition temperature from 40° C. to 120° C.

6. The adhesive composition of claim 1, wherein the lignin-based tackifying agent exhibits a glass transition temperature from 50° C. to 120° C.

7. The adhesive composition of claim 1, wherein the adhesive composition exhibits a softening point at a temperature below 120° C.

8. The adhesive composition of claim 1, wherein the adhesive composition exhibits a softening point at a temperature below 100° C.

9. The adhesive composition of claim 1, wherein the lignin-based tackifying agent comprises depolymerized lignin.

10. The adhesive composition of claim 1, wherein the lignin-based tackifying agent is a hydrogenated lignin-based tackifying agent.

11. The adhesive composition of claim 1, wherein the adhesive composition includes from 30% to 50% by weight the lignin-based tackifying agent, from 30% to 50% by weight the thermoplastic polymer, and from 15% to 30% by weight a wax, all based on the total weight of the adhesive composition.

12. An adhesive composition comprising:
a lignin-based tackifying agent exhibiting a glass transition temperature from 30° C. to 120° C. and having a weight average molecular weight of no greater than 6000; and
a thermoplastic polymer;
wherein the adhesive composition exhibits a softening point at a temperature below 160° C.

13. The adhesive composition of claim 12, wherein the lignin-based tackifying agent exhibits a glass transition temperature from 50° C. to 120° C.

14. The adhesive composition of claim 12, wherein the lignin-based tackifying agent comprises depolymerized lignin.

15. An adhesive composition comprising:
a lignin-based tackifying agent exhibiting a glass transition temperature from 30° C. to 120° C. and having a weight average molecular weight of no greater than 6000; and
a thermoplastic polymer;
wherein the adhesive composition exhibits a viscosity of no greater than 100,000 cP at a temperature from 177° C. to 178° C.

16. The adhesive composition of claim 15, wherein the lignin-based tackifying agent has a weight average molecular weight of no greater than 3000.

17. The adhesive composition of claim 15, wherein the adhesive composition exhibits a softening point at a temperature below 160° C.

18. The adhesive composition of claim 12, wherein the lignin-based tackifying agent has a weight average molecular weight of no greater than 3000.

19. The adhesive composition of claim 12, wherein the adhesive composition exhibits a softening point at a temperature below 120° C.

20. The adhesive composition of claim 12, wherein the adhesive composition exhibits a viscosity of no greater than 100,000 cP at a temperature from 177° C. to 178° C.
